(19) United States
(12) Patent Application Publication
(10) Pub. No.: US 2026/0059541 A1
(43) Pub. Date: Feb. 26, 2026

(54) METHODS AND APPARATUS FOR MULTIPLE DEFAULT BEAMS AND MULTIPLE TCI STATES WITH SINGLE DCI-BASED MULTI-CELL SCHEDULING

(71) Applicant: Apple Inc., Cupertino, CA (US)

(72) Inventors: Ankit Bhamri, Bad Nauheim (DE); Sigen Ye, Whitehouse Station, NJ (US); Wei Zeng, Saratoga, CA (US); Haitong Sun, Cupertino, CA (US); Hong He, San Jose, CA (US); Seyed Ali Akbar Fakoorian, San Diego, CA (US); Weidong Yang, San Diego, CA (US); Huaning Niu, San Jose, CA (US); Dawei Zhang, Saratoga, CA (US)

(21) Appl. No.: 19/102,479

(22) PCT Filed: Aug. 12, 2022
(86) PCT No.: PCT/CN2022/112243

§ 371 Date: Feb. 10, 2025

(51) Int. Cl. H04W 72/232; H04W 72/1273

(52) U.S. Cl. CPC H04W 72/232; H04W 72/1273

(57) ABSTRACT

Methods, systems, devices, and computer programs for determining a default beam for each of a plurality of cells. In one aspect, the method can include receiving, by a UE, multiple PDSCHs that are each associated with a different cell and scheduled by a single DCI, determining, by the UE, that the UE is in an operating state that triggers default beam selection for the multiple PDSCHs associated with multiple cells scheduled by single DCI, and determining, by the UE, a default beam for each of the multiple PDSCHs associated with one of the different cells.

### BACKGROUND

TCI states are used to indicate a transmission configuration for A UE. 3GPP has different categories of QCL relationships. These QCL relationships can be categorized into a plurality of QCL types including A, B, C, and D.

### SUMMARY

According to one innovative aspect of the present disclosure, a method for determining a default beam for each of a plurality of cells is disclosed. In one aspect, the method can include receiving, by a UE, multiple PDSCHs that are each associated with a different cell and scheduled by a single DCI, determining, by the UE, that the UE is in an operating state that triggers default beam selection for each the multiple PDSCHs that are each associated with a different cell scheduled by single DCI, and determining, by the UE, a default beam for each of the multiple PDSCHs associated with one of the different cells.

Other aspects include apparatuses, systems, and computer programs for performing the actions of the aforementioned method.

The innovative method can include other optional features. For example, in some implementations, the method can further include receiving, by a UE, network signaling from an access node that configures the UE to determine a default beam for multiple PDSCH that are each associated with a different cell scheduled by a single downlink control information (DCI).

In some implementations, the network signaling configures the UE to determine a default beam for multiple PDSCHs that are each associated with a different cell scheduled by a single downlink control information (DCI) by configuring an enableDefaultBeamForMCS RRC parameter.

In some implementations, determining, by the UE, that the UE is in an operating state that triggers default beam selection for each of the multiple PDSCHs can include determining, by the UE, that a tci-PresentInDCI parameter is not enabled.

In some implementations, determining, by the UE, that the UE is in an operating state that triggers default beam selection for each of the multiple PDSCHs can include determining, by the UE, whether a scheduling offset between the DCI and corresponding scheduled PDSCHs is shorter than the timeDurationForQCL.

In some implementations, the UE is configured with at least one enhanced CORESET configuration that associates at least one TCI state that corresponds to each of the different cells, and the UE received the multiple PDSCHs that are each associated with a different cell on the enhanced CORESET. In such implementations, determining, by the UE, a default beam for each of the multiple PDSCHs associated with one the different cells can include determining, by the UE, a default beam for each of the multiple PDSCHs based on enhanced CORESET configurations.

In some implementations, determining, by the UE, a default beam for each of the multiple PDSCHs based on enhanced CORESET can include selecting, for each particular PDSCHs of the multiple PDSCHs, the at least one TCI state identified by the enhanced CORESET configuration for the cell associated with receipt of the particular PDSCH.

In some implementations, the enhanced CORESET also associates (i) a serving cell ID or (ii) a component carrier (CC) index that corresponds to each of the different cells along with the TCI states.

In some implementations, the TCI states of the enhanced CORESET are mapped in sequential order to the different cells in the enhanced CORESET configuration.

In some implementations, the UE is configured with at least one enhanced CORESET configuration that associates at least one TCI state that corresponds to each of the different cells that can be scheduled by single DCI, and the UE received the multiple PDSCHs that are each associated with a different cell a CORESET that is not configured with the enhanced CORESET configuration. In such implementations, determining, by the UE, a default beam for each of the multiple PDSCHs associated with one the different cells can include determining, by the UE, a default beam for each of the multiple PDSCHs based on a CORESET having a lowest ID that is configured with multiple TCI states associated with the different cells.

In some implementations, the UE is configured with a CORESET configuration that associates at least one TCI state with only one cell. In such implementations, determining, by the UE, a default beam for each of the multiple PDSCHs associated with one the different cells can include using, by the UE, the at least one TCI state of the CORESET associated with the one cell as the default beam for the PDSCH associated with the one cell, and determining, by the UE, a default beam for each of the other PDSCHs based on the TCI state configured for the CORESET with a lowest index corresponding to each of the other PDSCHs.

In some implementations, the UE is semi-statically configured with a TCI state corresponding to each of the different cells that can be scheduled by single DCI, with the TCI state for each cell of the multiple cells having an associated index value and the UE has not received MAC CE to activate a subset of the TCI states. In such implementations, determining, by the UE, a default beam for each of the multiple PDSCHs associated with one the different cells can include determining, by the UE, default beams for each of the PDSCH associated with a different cell based on the TCI state with a lowest index among the configured TCI states for each of the scheduled cell.

In some implementations, the UE is semi-statically configured with a TCI state corresponding to each of the different cells, with the TCI state for each cell of the multiple cells having an associated index value, and the UE has received MAC CE that activates a subset of the TCI states for each of the different cells that can be scheduled by single DCI. In such implementations, determining, by the UE, a default beam for each of the multiple PDSCHs associated with one the different cells can include determining, by the UE, default beams for each of the PDSCH associated with a different cell based on the TCI state with lowest index among the activated TCI states for each of the different cells.

In some implementations, the UE is semi-statically configured with one or more TCI states corresponding to each of the different cells, the UE has received MAC CE that activates a subset of the TCI states for each of the different cells, an index may contain multiple TCI states and where each of the TCI state is associated with each of the cells that can be scheduled by single DCI, and multiple TCI states are indexed for at least one or more of the cells. In such implementations, determining, by the UE, a default beam for each of the multiple PDSCHs associated with one the different cells can include determining, by the UE, a default beam for each of the PDSCH associated with a different cell based on the lowest TCI index among the activated states.

In some implementations, the UE is configured with one set of TCI states, where the set of TCI states includes the default beams for each of the different cells that can be scheduled by the DCI, and the set of TCI states comprise one TCI state for each of the different cells that can be scheduled by DCI. In such implementations, determining, by the UE, a default beam for each of the multiple PDSCHs associated with one of the different cells can include determining, by the UE, the default beam for each of the multiple PDSCHs associated with one of the different cells based on the set of TCI states.

In some implementations, the UE is configured with multiple sets of TCI states, wherein the set of TCI states of the multiple sets of TCI states includes the default beams for each of the different cells that can be scheduled by the DCI, and wherein each set of TCI states comprises one TCI state for each of the different cells that can be scheduled by DCI. In such implementations, the method can further include receiving, by the UE, a MAC CE that activates a particular TCI set of the multiple TCI sets. In such implementations, determining, by the UE, a default beam for each of the multiple PDSCHs associated with one of the different cells can include determining, by the UE, the default beam for each of the multiple PDSCHs associated with one of the different cells based on the particular set of TCI states that was activated by the MAC CE.

According to one innovative aspect of the present disclosure, method for TCI configuration and indication is disclosed. In one aspect, the method can include actions of receiving, by a UE, a set of TCI states corresponding to each of a plurality of cells, receiving, by the UE, a MAC CE from a network that activates a set of multiple TCI-to-Cell mapping tables, wherein each TCI-to-Cell mapping table has one or more entries that associate a TCI table identifier with multiple cells that can be scheduled by a single DCI, wherein the TCI table identifier identifies a TCI state table specifying TCI states for the associated multiple cells, receiving, by the UE, a single DCI scheduling multiple cells and indicating TCI for multiple scheduled PDSCHs associated with multiple cells, determining, by the UE, a TCI-to-Cell mapping table from the activated set of multiple TCI-to-Cell mapping tables based on the multiple cells scheduled by the single DCI scheduling, and using, by the UE, the indicated TCI states from the determined TCI-to-Cell mapping table based on the TCI indication in the scheduling DCI.

Other aspects include apparatuses, systems, and computer programs for performing the actions of the aforementioned method.

The innovative method can include other optional features. For example, in some implementations, each TCI-to-Cell mapping table corresponds to a combination of cells that can be configured by the UE.

In some implementations, receiving, by a UE, a set of TCI states corresponding to each of a plurality of cells can include receiving RRC configuration, from the network, that configures the UE to include a set of TCI states corresponding to each of a plurality of cells.

In some implementations, the activated set of multiple TCI-to-Cell mapping tables can include (i) a first TCI-to-Cell mapping table, wherein the first TCI-to-Cell mapping table associates a first TCI table identifier with a first cell and a second cell, wherein each index of the TCI state table identified by the first TCI table identifier comprises at least two TCI states corresponding to the first cell and second cell, (ii) a second TCI-to-Cell mapping table, wherein the second TCI-to-Cell mapping table associates a second TCI table identifier with the first cell and a third cell, wherein each index of the TCI state table identified by the second TCI table identifier comprises at least two TCI states corresponding to the first cell and the third cell, (iii) a third TCI-to-Cell mapping table, wherein the third TCI-to-Cell mapping table associates a third TCI table identifier with the second cell and a third cell, wherein each index of the TCI state table identified by the third TCI state table identifier comprises at least two TCI states corresponding to the second cell and the third cell, and (iv) a fourth TCI-to-Cell mapping table, wherein the fourth TCI-to-Cell mapping table associates a fourth TCI table identifier with the first cell, the second cell, and a third cell, wherein each index of the TCI state table identified by the fourth TCI state table identifier comprises at least three TCI states corresponding to the first cell, the second cell, and the third cell.

In some implementations, the received single DCI can schedule the first cell and the second cell. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the first cell and the second cell were scheduled by the single DCI, determining, by the UE, that the first TCI-to-Cell mapping table is to be used to indicate TCI states for the first cell and the second cell.

In some implementations, the received single DCI can schedule the first cell and the third cell. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the first cell and the third cell were scheduled by the single DCI, determining, by the UE, that the second TCI-to-Cell mapping table is to be used to indicate TCI states for the first cell and the third cell.

In some implementations, the received single DCI can schedule the second cell and the third cell. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the second cell and the third cell were scheduled by the single DCI, determining, by the UE, that the third TCI-to-Cell mapping table is to be used to indicate TCI states for the second cell and the third cell.

In some implementations, the received single DCI can schedule the first cell, the second cell and the third cell. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the first cell, the second cell and the third cell were scheduled by the single DCI, determining, by the UE, that the fourth TCI-to-Cell mapping table is to be used to indicate TCI states for the first cell, the second cell, and the third cell.

In some implementations, the activated a set of multiple TCI-to-Cell mapping tables can include (i) a first TCI-to-Cell mapping table, wherein the first TCI-to-Cell mapping table associates a first TCI table identifier with a first group of cells, wherein each index of the TCI state table identified by the first TCI table identifier comprises at least one TCI state corresponding to each cell in the first group of cells, (ii) a second TCI-to-Cell mapping table, wherein the second TCI-to-Cell mapping table associates a second TCI table identifier with a second group of cells, wherein each index of the TCI state table identified by the second TCI table identifier comprises at least one TCI state corresponding to each cell in the second group of cells and, (iii) a third TCI-to-Cell mapping table, wherein the third TCI-to-Cell mapping table associates a third TCI table identifier with third group of cells, wherein each index of the TCI state table identified by the third TCI table identifier comprises at least one TCI state corresponding to each cell in the third group of cells.

In some implementations, the received single DCI can schedule the first group of cells. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the first group of cells were scheduled by the single DCI, determining, by the UE, that the first TCI-to-Cell mapping table is to be used to indicate TCI states for the first group of cells.

In some implementations, the received single DCI can schedule the second group of cells. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the second group of cells were scheduled by the single DCI, determining, by the UE, that the second TCI-to-Cell mapping table is to be used to indicate TCI states for the second group of cells.

In some implementations, the received single DCI can schedule the third group of cells. In such implementations, determining, by the UE, a TCI-to-Cell mapping table from the activated set of multiple TCI-to-Cell mapping tables is based on the multiple cells scheduled by the single DCI scheduling can include based on a determination, by the UE, that the third group of cells were scheduled by the single DCI, determining, by the UE, that the third TCI-to-Cell mapping table is to be used to indicate TCI states for the third group of cells.

According to another innovative aspect of the present disclosure, another method for TCI configuration and indication is disclosed. In one aspect, the method can include actions of receiving, by a UE, a TCI-to-Cell mapping table that includes a plurality of entries, wherein each entry of the plurality of entries associates a TCI table index and a group of one or more cells that can be scheduled by a single DCI, receiving, by the UE, MAC CE that activates a subset of TCI table indices of the configured TCI-to-Cell mapping table, receiving, by the UE, a single DCI scheduling multiple cells and indicating TCI for multiple scheduled PDSCHs associated with multiple cells, determining, by the UE and based on the received single DCI, a TCI table index of the activated TCI table indices, and using, by the UE, the indicated TCI and applying the TCI states associated with the determined TCI table index for the scheduled cells.

Other aspects include apparatuses, systems, and computer programs for performing the actions of the aforementioned method.

The innovative method can include other optional features. For example, in some implementations, receiving, by a UE, a table that includes a plurality of entries, wherein each entry of the plurality of entries associate a TCI table index and a TCI state for a group of one or more cells that can be scheduled by a single DCI can include receiving RRC configuration, from the network, that configures the UE to include a table that includes a plurality of entries, wherein each entry of the plurality of entries associate a TCI table index and a TCI state for a group of one or more cells that can be scheduled by a single DCI.

In some implementations, the activated subset of TCI table indices can include (i) a first TCI table index, wherein the first TCI table index indicates a TCI state for first group of one or more cells, (ii) a second TCI table index, wherein the second TCI table index indicates a TCI state for a second group of one or more cells, (iii) a third TCI table index, wherein the third TCI table index indicates a TCI state for a third group of one or more cells, and (iv) a third TCI table index, wherein the fourth TCI table index indicates a TCI state for a fourth group of one or more cells.

In some implementations, the first group of the one or more cells can include multiple cells, the second group of one or more cells can include multiple cells, the third group of one or more cells multiple cells can include multiple cells, or the fourth group of one or more cells can in include multiple cells.

In some implementations, the first group of the one or more cells can include multiple cells, the second group of one or more cells can include multiple cells, the third group of one or more cells multiple cells can include multiple cells, and the fourth group of one or more cells can in include multiple cells.

In some implementations, the UE receives a single DCI scheduling the first group of one or more cells. In such implementations, determining, based on the received single DCI, a TCI table index of the activated TCI table indices can include determining, by the UE, to use the first TCI table index for the scheduled first group of one or more cells.

In some implementations, the UE receives a single DCI scheduling the second group of multiple cells. In some implementations, determining, based on the received single DCI, a TCI table index of the activated TCI table indices can include determining, by the UE, to use the second TCI table index for the scheduled second group of multiple cells.

In some implementations, the UE receives a single DCI scheduling the third group of multiple cells. In such implementations, determining, based on the received single DCI, a TCI table index of the activated TCI table indices can include determining, by the UE, to use the third TCI table index for the scheduled third group of multiple cells.

In some implementations, the UE receives a single DCI scheduling the fourth group of multiple cells. In such implementations, determining, based on the received single DCI, a TCI table index of the activated TCI table indices can include determining, by the UE, to use the fourth TCI table index for the scheduled fourth group of multiple cells.

According to another innovative aspect of the present disclosure, another method for TCI configuration and indication is disclosed. In one aspect, the method can include receiving, by a UE, a TCI-to-Cell mapping table that includes a plurality of entries, wherein each entry of the plurality of entries associates a TCI table index and a group of one or more cells that can be scheduled by a single DCI, receiving, by the UE, a MAC CE that activates a subset of TCI table indices of the configured TCI-to-Cell mapping table, receiving, by the UE, a single DCI indicating TCI for multiple scheduled PDSCHs associated with multiple cells, determining, by the UE and based on the received single DCI, a TCI table index of the activated TCI table indices, and using, by the UE, the indicated TCI and applying the TCI states associated with the determined TCI table index for the scheduled cells.

In some implementations, receiving, by a UE, a table that includes a plurality of entries, wherein each entry of the plurality of entries associate a TCI table index and a TCI state for a group of one or more cells that can be scheduled by a single DCI can include receiving RRC configuration, from the network, that configures the UE to include a table that includes a plurality of entries, wherein each entry of the plurality of entries associate a TCI table index and a TCI state for a group of one or more cells that can be scheduled by a single DCI.

In some implementations, the activated subset of TCI table indices can include (i) a first TCI table index, wherein the first TCI table index includes a first column indicating first group of cells comprising at least a first cell and a second column indicating a TCI state for the first cell, (ii) a second TCI table index, wherein the second TCI table index includes a first column indicating a second group of cells comprising at least the first cell and a second cell, a second column indicating a TCI state for the first cell, and a third column indicating a TCI state for the second cell, (iii) a third TCI table index, wherein the third TCI table index includes a first column indicating a third group of cells comprising the first cell and a third cell, a second column indicating a TCI state for the first cell, and a third column indicating a TCI state for the third cell, (iv) a fourth TCI table index, wherein the fourth TCI table index includes a first column indicating a fourth group of cells comprising the second cell and the third cell, a second column indicating a TCI state for the second cell, and a third column indicating a TCI state for the third cell, and (v) a fifth TCI table index, wherein the fifth TCI table index includes a first column indicating a fifth group of cells comprising the first cell, the second cell, and the third cell, a second column indicating a TCI state for the first cell, a third column indicating a TCI state for the second cell, and a fourth column indicating a TCI state for the third cell.

In some implementations, the first group of the one or more cells can include multiple cells, the second group of one or more cells comprises multiple cells, the third group of one or more cells comprises multiple cells, the fourth group of one or more cells comprises multiple cells, or the fifth group of one or more cells comprises multiple cells.

In some implementations, the first group of the one or more cells can include multiple cells, the second group of one or more cells comprises multiple cells, the third group of one or more cells comprises multiple cells, the fourth group of one or more cells comprises multiple cells, and the fifth group of one or more cells comprises multiple cells.

In some implementations, the received single DCI indicating TCI for multiple scheduled PDSCHs associated with multiple cells comprises an indication of a TCI table index.

In some implementations, the received DCI indicating TCI corresponds to the first TCI table index. In such implementations, determining, by the UE, that the cells to be scheduled by the received single DCI includes the first group of one or more cells based on the first column of the first TCI table index.

In some implementations, the received DCI indicating TCI corresponds to the second TCI table index. In some implementations, determining, by the UE, that the cells to be scheduled by the received single DCI include the second group of one or more cells based on the first column of the second TCI table index.

In some implementations, the received DCI indicating TCI corresponds to the first TCI table index. In such implementations, determining, based on the received single DCI, a TCI table index of the activated TCI table indices can include determining, by the UE, to use the first TCI table index, and using, by the UE, the indicated TCI and applying the TCI states in the determined TCI table index for the scheduled cells can include using, by the UE, the indicated TCI and applying the TCI states in second column of the first TCI table index for the scheduled cells.

In some implementations, the received DCI indicating TCI corresponds to the second TCI table index. In such implementations, determining, based on the received single DCI, a TCI table index of the activated TCI table indices can include determining, by the UE, to use the second TCI table index, and using, by the UE, the indicated TCI and applying the TCI states in the determined TCI table index for the scheduled cells can include using, by the UE, the indicated TCI and applying the TCI states in second column of the second TCI table index and the third column of the second TCI Table index for the scheduled cells.

In some implementations, the received DCI indicating TCI corresponds to the third TCI table index. In such implementations, determining, based on the received single DCI, a TCI table index of the activated TCI table indices can include determining, by the UE, to use the third TCI table index, and using, by the UE, the indicated TCI and applying the TCI states in the determined TCI table index for the scheduled cells can include using, by the UE, the indicated TCI and applying the TCI states in second column of the third TCI table index and the third column of the third TCI Table index for the scheduled cells.

In some implementations, the received DCI indicating TCI corresponds to the fifth TCI table index. In such implementations, determining, based on the received single DCI, a TCI table index of the activated TCI table indices can include determining, by the UE, to use the fifth TCI table index and using, by the UE, the indicated TCI and applying the TCI states in the determined TCI table index for the scheduled cells can include using, by the UE, the indicated TCI and applying the TCI states in second column of the third TCI table index, the third column of the fifth TCI Table index, and the fourth column of the fifth TCI table index for the scheduled cells.

### BRIEF DESCRIPTION OF DRAWINGS

FIG. 1 is a flowchart of an example of a process for UE to select a default transmission beam for each of a plurality of physical data shared channels (PDSCHs) associated with multiple cells using a single downlink control information (DCI).

FIG. 2 is a flowchart of an example of a process for TCI configuration and indication.

FIG. 3 is a flowchart of an example of another process for TCI configuration and indication.

FIG. 3A is a flowchart of an example of another process for TCI configuration and indication.

FIG. 4 is an example of a wireless communication system.

FIG. 5 is a block diagram of an example of user equipment (UE).

FIG. 6 is a block diagram of an example of an access node.

Like reference symbols in the various drawings indicate like elements.

### DETAILED DESCRIPTION

In 5G NR systems, when a transmission beam or beam (TCI QCL type-D) is indicated by the DCI, it is applied to the scheduled PDSCH, but only when the timeDurationForQCL (time offset to apply the indicated beam) is less than or equal to the scheduling offset (which is the time offset between the last symbol of the scheduling DCI and the starting symbol of the scheduled PDSCH). In implementations, if the time offset for beam is longer than the scheduling offset, then a default beam is applied to the scheduled PDSCH. Additionally, if tci-PresentInDCI is not enabled, then also the UE is expected to apply default beam.

In conventional systems, a single downlink control information (DCI) is only able to performing scheduling operations for a single cell. Thus, when scheduling is performed for N cells, with N being greater than 1, multiple (i.e., N) DCI transmissions need to occur. As the number N rises, this can result in significant signaling overheard for the network.

Techniques of the present disclosure aim to solve this problem by enabling N cell scheduling, where N is greater than 1 (referred to herein as “multi-cell scheduling”), with only a single DCI transmission. Using only a single DCI transmission to perform multi-cell scheduling will reduce signaling overhead for the network, thereby freeing up network resources for other uses. Accordingly, the present disclosure provides solutions to configure and determine default beams that can be associated with multiple PDSCHs corresponding to multiple cells scheduled by single DCI.

In addition, the indication of TCI needs to be enhanced for multiple cell scenario by single DCI. Accordingly, in this disclosure, we also provide solutions to configure, activate and indicate TCI states for multiple cells scheduled by single DCI.

For purposes of this disclosure, a TCI state refer to a Transmission Configuration Indicator (TCI) states. Such TCI states, once determined or otherwise selected using the techniques of the present disclosure, can be used by the various implementations to indicate configurations such as QCL-relationships between a source RS and target RS to transmit or receive the target RS and associated channel, for example the source RS can be one CSI-RS ID and the target could be PDSCH DMRS ports that can be used and the QCL assumption can be type-D, by a UE.

### Default Beam Determination for Multi-Cell Scheduling Overview

Procedures for default beam determination for multi-cell scheduling overview are disclosed. A UE can be configured by enableDefaultBeamForMCS (Multi-Cell Scheduling), and upon configured with the parameter, UE is expected to be able to determine default beams for multiple PDSCH associated with multiple cells scheduled by single DCI, in at least following cases:
tci-PresentInDCI is not enabled, i.e. the scheduling DCI is not expected to contain the TCI indication field and in this case, default beam (e.g., TCI state with QCL type-D) is needed for the PDSCH reception (antenna ports associated with PDSCH) at the UE;
Scheduling offset between the DCI and corresponding scheduled PDSCHs is shorter than the timeDurationForQCL, i.e. there is not enough time between the DCI reception and applying the indicated beam at the start of PDSCH reception at UE.
   In such cases, the default beams for each of the PDSCH associated with multiple cells can be determined using one or more of the following implementations.

In a first implementation, for example, default beams for each of the PDSCH associated with multiples cells can be determined using a CORESET (associated with serving cell) used for PDCCH carrying multi-cell scheduling DCI is configured with at least one TCI state (with QCL type-D assumption) corresponding to each of the scheduled cell.

In this first implementation for determining the default beam for the scheduled PDSCHs associated with different cells, UE is configured with at least one enhanced CORESET configuration that is associated with at least one TCI state corresponding to each of the cells (that can be scheduled by single DCI) and the UE receives the PDCCH carrying multi-cell scheduling DCI on the CORESET configured with that enhanced configuration.

As an example of this implementation, if 4 cells can be scheduled by a serving cells then at least one TCI state corresponding to each of the 4 cells is configured for at least one CORESET associated with serving cell.

As an alternative to the first implementation, the serving cell ID and/or CC index is also explicitly configured along with the TCI states in the enhanced CORESET configuration.

As another alternative to the first implementation, In another alternative, the TCI states can be mapped in sequential order to the scheduled cells, where the scheduled cells ID and/or CC index is indicated separately, for example via DCI.

In a second implementation, for example, default beams for each of the PDSCH associated with multiples cells can be determined using a CORESET (associated with serving cell) with lowest CORESET ID and configured with at least once TCI state (with QCL type-D assumption) corresponding to each of the cell that can be scheduled.

In this second implementation for determining the default beam for the scheduled PDSCHs associated with different cells, UE is configured with at least one enhanced CORESET configuration that is associated with at least one TCI state corresponding to each of the cells (that can be scheduled by single DCI) and the UE receives the PDCCH carrying multi-cell scheduling DCI on the CORESET not configured with that enhanced configuration and UE determines the TCI states for all the scheduled cells based on the CORESET with lowest ID that is configured with multiple TCI states associated with multiple cells.

This second implementation is different from the first implementation as the CORESET associated with the received PDCCH for multi-cell scheduling is not configured with multiple TCI states for multiple cells. Therefore, the other CORESET configured to UE with multiple TCI states for multiple cells and with lowest CORESET ID is used to determine default beam for all the scheduled cells.

As an example of the second implementation, if CORESET with index 2 is scheduling multiple cells (with single DCI), but it is not configured with multiple TCI states for multiple cells, and CORESET with index 1 is configured with multiple TCI states for multiple cells, then the TCI states from CORESET index 1 are used to determine the default beams for the scheduled cells.

In an alternative this example of the second implementation, the default beam for the serving cell can be determined from the TCI state of CORESET index 2 (if configured)

In a third implementation, for example, default beams for each of the PDSCH associated with multiples cells can be determined using lowest CORESET IDs (associated with each of the scheduled cells) and configured with at least once TCI state (with QCL type-D assumption) corresponding to associated cells.

In this third implementation for determining the default beam for the scheduled PDSCHs associated with different cells, if UE is not configured with enhanced CORESET configuration with multiple TCI states for multiple cells, then UE determines the default beam for the scheduling cell (if scheduled) based on the TCI state configured for the CORESET associated with the PDCCH carrying multi-cell scheduling DCI. The UE determines the default beam for the other scheduled cells (other than the scheduling cells) based on the TCI state configured for the CORESET with lowest index corresponding to each of the scheduled cell

As an example of the third implementation, if serving cell is cell 1 and it schedules cell 1, cell 2 and cell 3, then the default beam for cell 1 is based on the TCI state of the CORESET of serving cell (i.e. cell 1) that is associated with the scheduling PDCCH and the default beam for cell 2 is based on TCI state of CORESET with lowest index (such as index 0) associated with cell 2 and similarly the default beam for cell 2 is based on TCI state of CORESET with lowest index (such as index 0).

If CORESET index 0 is not configured with TCI, but a higher index (such as index 1) is configured with TCI state, then that TCI state is used to determine default beam for the corresponding cell.

In a fourth implementation, for example, default beams for each of the PDSCH associated with multiples cells can be determined using an activated TCI state with lowest index corresponding to each of the scheduled cell.

In this fourth implementation for determining the default beam for the scheduled PDSCHs associated with different cells, if the UE is semi-statically configured with TCI states corresponding to each of cells, but not activated by MAC CE with a subset of TCI states, then the default beams for each of the scheduled PDSCH associated with multiple cells by single DCI is determined based on the TCI state with lowest index among the configured stated for each of the scheduled cell, respectively.

In a fifth implementation, for example, default beams for each of the PDSCH associated with multiples cells can be determined using configured TCI state with lowest index corresponding to each of the scheduled cell (if not activated).

In this fifth implementation for determining the default beam for the scheduled PDSCHs associated with different cells, if the UE is semi-statically configured with TCI states corresponding to each of cells and also activated by MAC CE with a subset of TCI states for each of the cells, then the default beams for each of the scheduled PDSCH associated with multiple cells by single DCI is determined based on the TCI state with lowest index among the activated states for each of the scheduled cell, respectively. If only some of the cells have activated TCI states, then for those cells, the configured TCI states can be used for default beam determination as described in the fourth implementation.

In a sixth implementations, for example, default beams for each of the PDSCH associated with multiples cells can be determined using a lowest index from an activated TCI table, where at least one index of the activated TCI table consists of at least the same number of cells as scheduled by the DCI.

In this sixth implementation for determining the default beam for the scheduled PDSCHs associated with different cells, if the UE is activated with a set of TCI states, wherein an index may contain multiple TCI states and where each of the TCI state is associated with each of the cells that can be scheduled by single DCI, then the default beams for each of the scheduled cells is based on the lowest TCI index among the activated states, where multiple TCI states are contained for multiple cells.

Mapping of the TCI states (within on index) are mapped in sequential manner to the cells in increasing order. For example, index 0 contains TCI state 3, TCI state 2 and TCI state 7, then cell 0 is mapped to TCI state 3, cell 1 is mapped to TCI state 2 and cell 2 is mapped to TCI state 7.

In a seventh implementation, a dedicated configuration for a default beam is employed.

In this seventh implementation for determining the default beam for the scheduled PDSCHs associated with different cells, a UE is configured with one or more sets of TCI states, where each set of TCI State includes the default beams for all the serving cells that can be scheduled by the DCI, with one TCI State per cell.

If a single set is configured in the seventh implementation, the TCI states are used as the default beams.

Alternatively, if multiple sets are configured in the seventh implementation, one of the sets may be activated by MAC CE, and the TCI states in the activated set are used as the default beams.

As an exception to the seventh implementations, if the scheduling cell (where DCI is transmitted) is also scheduled, the TCI State of the PDSCH follows the TCI State of the CORESET on which the DCI is transmitted, if configured.

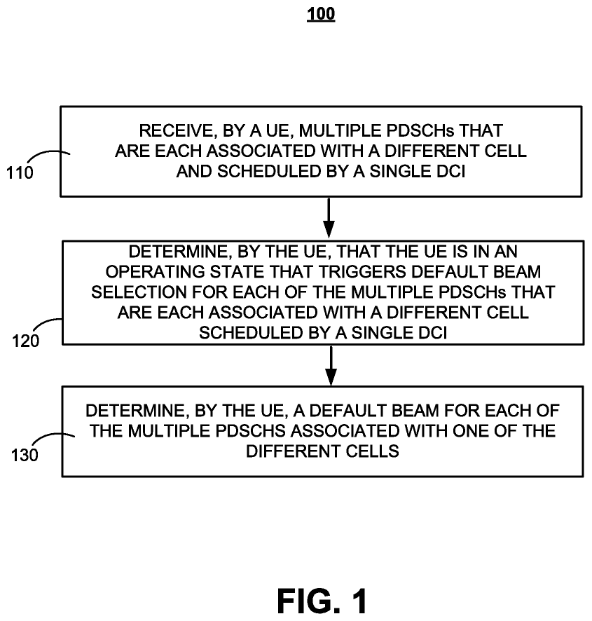

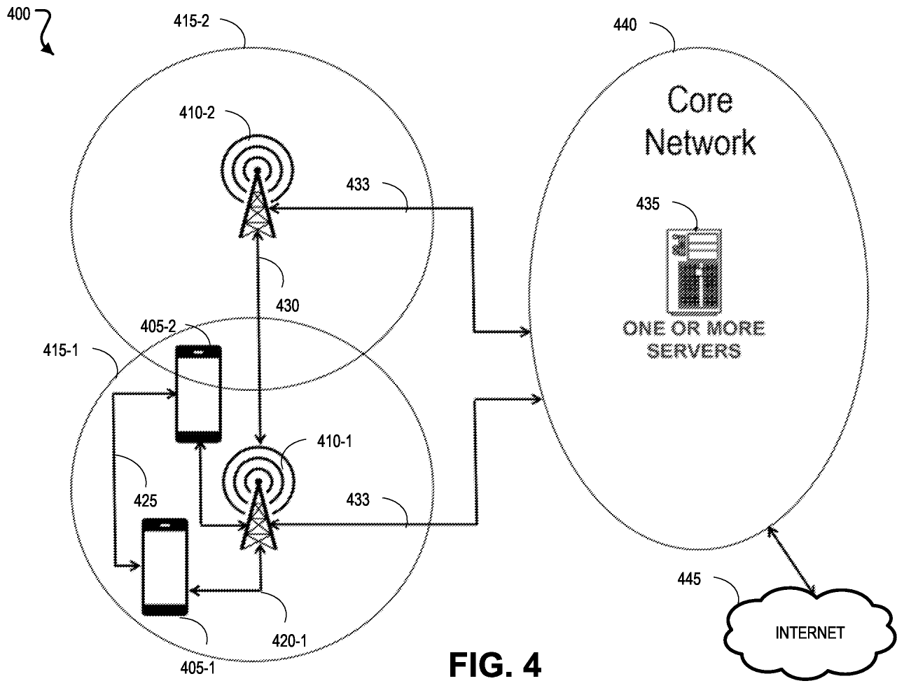

FIG. 1 is a flowchart of an example of a process 100 for UE to select a default transmission beam for each of a plurality of physical data shared channels (PDSCHs) associated with multiple cells using a single downlink control information (DCI). The process 100 will be described as being performed by a UE such as a UE 405 of FIG. 4.

The UE can begin execution of the process 100 by receiving multiple PDSCHs that are each associated with a different cell and scheduled by single DCI (110). In some implementations, the UE is a UE that has been configured, for example, to determine a default beam for each of the multiple PDSCHs that are each associated with a different cell scheduled by a single downlink control information (DCI).

The UE can continue execution of the process 100 by determining that the UE is in an operating state that triggers default beam selection for each of the multiple PDSCHs that are each associated with a different cell scheduled by single DCI (120). In some implementations, the UE can determine that the UE is in an operation state that triggers default beam selection for each of the multiple PDSCHs by determining that the tci-PresentInDCI parameter is not enabled. In some implementations, UE can determine that the UE is in an operation state that triggers default beam selection for each of the multiple PDSCHs by determining that a scheduling offset between the DCI and corresponding scheduled PDSCHs is shorter than the timeDurationForQCL.

The UE can continue execution of the process 100 by determining a default beam for each of the multiple PDSCHs associated with one of the different cells (130).

In some implementations, the UE is configured with at least one enhanced CORESET configuration that associates at least one TCI state that corresponds to each of the different cells, and the UE receives the multiple PDSCHs that are each associated with a different cell on the enhanced CORESET configuration. In such implementations, the UE's determination at stage 130 can include the UE determining a default beam for each of the multiple PDSCHs based on enhanced CORESET. In such implementations, the UE's determination at stage 130 can further include determining a default beam for each of the multiple PDSCHs based on enhanced CORESET by selecting, for each particular PDSCHs of the multiple PDSCHs, the at least one TCI state identified by the enhanced CORESET configuration for the cell associated with receipt of the particular PDSCH. In some implementations, the enhanced CORESET also associates (i) a serving cell ID or (ii) a component carrier (CC) index that corresponds to each of the different cells along with the TCI states. In some implementations, the TCI states of the enhanced CORESET are mapped in sequential order to the different cells in the enhanced CORESET configuration.

For purposes of the present disclosure, the term “enhanced CORESET” is intended to mean a CORESET that includes one or more TCI states associated with each cell of multiple cells capable of being scheduled using a single DCI. In contrast, a CORESET that is not “enhanced” only stores one or more TCI states for a single scheduled cell.

In some implementations, the UE is configured with at least one enhanced CORESET configuration that associates at least one TCI state that corresponds to each of the different cells that can be scheduled by single DCI, and the UE received the multiple PDSCHs that are each associated with a different cell a CORESET that is not configured with the enhanced CORESET configuration. In such implementations, the UE's determination at stage 130 can include the UE determining a default beam for each of the multiple PDSCHs based on a CORESET having a lowest ID that is configured with multiple TCI states associated with the different cells.

In some implementations, the UE is configured with a CORESET configuration that associates at least one TCI state with only one cell. In such implementations, the UE's determination at stage 130 can include determining a default beam for each of the PDSCH associated with a different cell by using, by the UE, the at least one TCI state of the CORESET associated with the one cell as the default beam for the PDSCH associated with the one cell, and determining, by the UE, a default beam for each of the other PDSCHs based on the TCI state configured for the CORESET with a lowest index corresponding to each of the other PDSCHs.

In some implementations, the UE is semi-statically configured with a TCI state corresponding to each of the different cells that can be scheduled by single DCI, with the TCI state for each cell of the multiple cells having an associated index value, and the UE has not received MAC CE to activate a subset of the TCI states. In such implementations, the UE's determination at stage 130 can include determining a default beam for each of the PDSCH associated with a different cell based on the TCI state with a lowest index among the configured TCI states for each of the scheduled cell.

In some implementations, the UE is semi-statically configured with a TCI state corresponding to each of the different cells that can be scheduled by single DCI, with the TCI state for each cell of the multiple cells having an associated index value. In some implementations, the associated index value can be implicitly determined by, e.g., sequential indexing. In other implementations, the associated index values can be explicitly determined for cell corresponding to each of the TCI states. In such implementations, the UE can receive MAC CE that activates a subset of the TCI states for each of the different cells that can be scheduled by single DCI. In such implementations, the UE's determination at stage 130 can include determining a default beam for each of the PDSCH associated with a different cell based on the TCI state with lowest index among the activated TCI states for each of the different cells.

In some implementations, the UE is semi-statically configured with one or more TCI states corresponding to each of the different cells. In such implementations, the UE can receive MAC CE that activates a subset of the TCI states for each of the different cells, wherein an index may contain multiple TCI states and where each of the TCI state is associated with each of the cells that can be scheduled by single DCI. In such implementations, multiple TCI states are indexed for at least one or more of the cells. In such implementations, the UE's determining at stage 130 can include determining a default beam for each of the PDSCH associated with a different cell based on the lowest TCI index among the activated states.

In some implementations, the UE is configured with one set of TCI states, where the set of TCI states includes the default beams for each of the different cells that can be scheduled by the DCI. In such implementations, the set of TCI states comprises one TCI state for each of the different cells that can be scheduled by DCI. In such implementations, the UE's determination at stage 130 can include determining the default beam for each of the multiple PDSCHs associated with one of the different cells based on the set of TCI states.

In some implementations, the UE is configured with multiple sets of TCI states, where the set of TCI states of the multiple sets of TCI states includes the default beams for each of the different cells that can be scheduled by the DCI, wherein each set of TCI states comprises one TCI state for each of the different cells that can be scheduled by DCI. In such implementations, the UE can continue execution of the process 100 by receiving a MAC CE that activates a particular TCI set of the multiple TCI sets. In such implementations, the UE's determination at stage 1310 can include determining the default beam for each of the multiple PDSCHs associated with one of the different cells based on the particular set of TCI states that was activated by the MAC CE.

In some implementations, the UE can continue execution of the process 100 by receiving network signaling from an access node that configures the UE to determine a default beam for multiple PDSCH that are each associated with a different cell scheduled by a single downlink control information (DCI). In some implementations, the network signaling configures the UE to determine a default beam for multiple PDSCH that are each associated with a different cell scheduled by a single downlink control information (DCI) by configuring an enableDefaultBeamForMCS radio resource control (RRC) parameter.

### First Implementation for TCI Indication Enhancement

One aspect of the present disclosure is directed towards TCI indication enhancements. If a UE is capable of supporting up to N cell scheduling by single DCI and if UE is capable of supporting (and if configured) indication of TCI states for multiple cells via a single DCI field (joint field in the DCI), then the UE can be activated by MAC CE with multiple tables corresponding to multiple combinations of cells that can be configured by UE and depending up on the actual scheduled cells by single DCI, the corresponding table is used for indication of TCI states for the corresponding cells.

An illustration of this implementation is shown below.
UE can be scheduled with a total of up to 3 cells by single DCI, such as cell 0, cell 1 and cell 2
For cell 0, UE is configured with 128 TCI states and similarly another two sets of 128 TCI states configured for cell 1 and cell 2, respectively
UE receives a MAC CE command to activate multiple sets/tables of TCI states (in addition to TCI tables for single cell) such as:
   TCI table 1 for cell 0 and cell 1, where each index contains at least 2 TCI states corresponding to cell 0 and cell 1
   TCI table 2 for cell 0 and cell 2, where each index contains at least 2 TCI states corresponding to cell 0 and cell 2
   TCI table 3 for cell 1 and cell 2, where each index contains at least 2 TCI states corresponding to cell 1 and cell 2
   TCI table 4 for cell 0, cell 1 and cell 2, where each index contains at least 3 TCI states corresponding to cell 0, cell 1 and cell 2

For the aforementioned example, sequential mapping of TCI state within an index can be assumed.

The UE can then receive a single DCI scheduling multiple cells, and based on scheduled cells, UE uses one of the activated TCI tables:
If cell 0 and cell 1 are scheduled, then TCI table 1 is used
If cell 0 and cell 2 are scheduled, then TCI table 2 is used
If cell 1 and cell 2 are scheduled, then TCI table 3 is used
If all cell are scheduled, then TCI table 4 is used

In one implementation of the solution, the number of activated states for each of the table can depend on the associated number of cells. This can be fixed or semi-statically configured. For example, with two cells, 8 states can be activated and with three cells, 16 states can be activated. Correspondingly, the number of DCI bits to indicate TCI can also be adjusted.

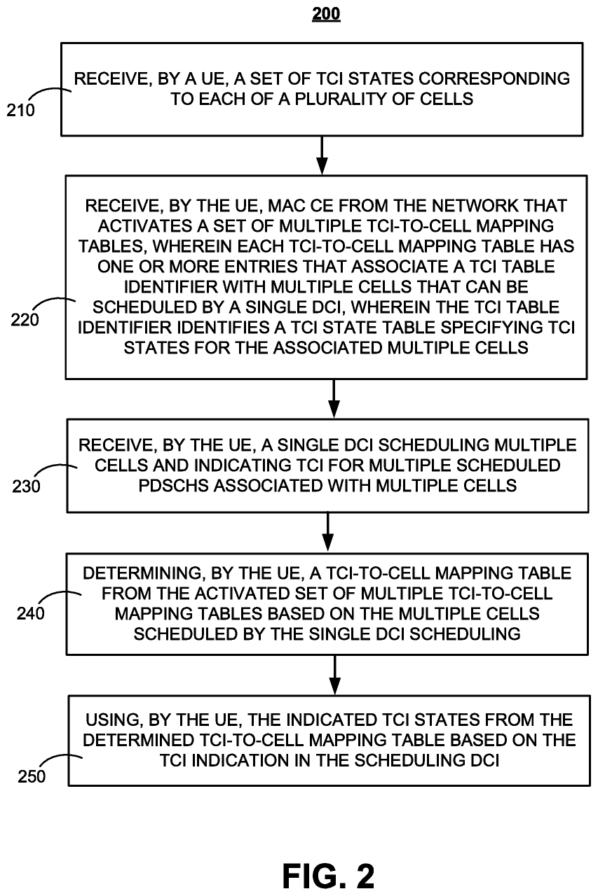

FIG. 2 is a flowchart of an example of a process 200 for TCI configuration and indication. The process 200 will be described as being performed by a UE such as a UE 405 of FIG. 4.

A UE can begin execution of the process 200 by receiving a set of TCI states corresponding to each of a plurality of cells (210). In some implementations, execution of the receiving operation at stage 210 can include the UE receiving RRC configuration, from the network, that configures the UE to include a set of TCI states corresponding to each of a plurality of cells.

The UE can continue execution of the process 200 by receiving MAC CE from the network that activates a set of multiple TCI-to-Cell mapping tables, wherein each TCI-to-Cell mapping table has one or more entries that associate a TCI table identifier with multiple cells that can be scheduled by a single DCI, wherein the TCI table identifier identifies a TCI state table specifying TCI states for the associated multiple cells (220). In some implementations, each TCI-to-Cell mapping table corresponds to a combination of cells that can be configured by the UE.

The UE can continue execution of the process 200 by receiving a single DCI scheduling multiple cells and indicating TCI for multiple scheduled PDSCHs associated with multiple cells (230).

The UE can continue execution of the process 200 by determining a TCI-to-Cell mapping table from the activated set of multiple TCI-to-Cell mapping tables based on the multiple cells scheduled by the single DCI scheduling (240).

The UE can continue execution of the process 200 by using the indicated TCI states from the determined TCI-to-Cell mapping table based on the TCI indication in the scheduling DCI (250). In some implementations, using the indicated TCI states from the determined TCI-to-Cell mapping table can include, for example, using the TCI states to indicate a transmission configuration for A UE. For example, TCI states can define one or more QCL-relationships between resources in a resource set and a PDSCH DMRS port.

In some implementations, a first set of multiple TCI-to-Cell mapping tables can be activated by MAC CE. In such implementations, the first set of activated TCI-to-Cell mapping tables can include (i) a first TCI-to-Cell mapping table, wherein the first TCI-to-Cell mapping table associates a first TCI table identifier with a first cell and a second cell, wherein each index of the TCI state table identified by the first TCI table identifier comprises at least two TCI states corresponding to the first cell and second cell, (ii) a second TCI-to-Cell mapping table, wherein the second TCI-to-Cell mapping table associates a second TCI table identifier with the first cell and a third cell, wherein each index of the TCI state table identified by the second TCI table identifier comprises at least two TCI states corresponding to the first cell and the third cell, (iii) a third TCI-to-Cell mapping table, wherein the third TCI-to-Cell mapping table associates a third TCI table identifier with the second cell and a third cell, wherein each index of the TCI state table identified by the third TCI state table identifier comprises at least two TCI states corresponding to the second cell and the third cell, and (iv) a fourth TCI-to-Cell mapping table, wherein the fourth TCI-to-Cell mapping table associates a fourth TCI table identifier with the first cell, the second cell, and a third cell, wherein each index of the TCI state table identified by the fourth TCI state table identifier comprises at least three TCI states corresponding to the first cell, the second cell, and the third cell.

In some implementations using the first set of activated TCI-to-Cell mapping tables identified above, the received single DCI can schedule the first cell and the second cell. In such implementations, execution of the determination stage 240 by the UE can include based on a determination, by the UE, that the first cell and the second cell were scheduled by the single DCI, determining, by the UE, that the first TCI-to-Cell mapping table is to be used to indicate TCI states for the first cell and the second cell.

In some implementations using the first set of activated TCI-to-Cell mapping tables identified above, the received single DCI can schedule the first cell and the third cell. In such implementations, execution of the determination stage 240 by the UE can include based on a determination, by the UE, that the first cell and the third cell were scheduled by the single DCI, determining, by the UE, that the second TCI-to-Cell mapping table is to be used to indicate TCI states for the first cell and the third cell.

In some implementations using the first set of activated TCI-to-Cell mapping tables identified above, the received single DCI can schedule the second cell and the third cell. In such implementations, execution of the determination stage 240 by the UE can include based on a determination, by the UE, that the second cell and the third cell were scheduled by the single DCI, determining, by the UE, that the third TCI-to-Cell mapping table is to be used to indicate TCI states for the second cell and the third cell.

In some implementations using the first set of activated TCI-to-Cell mapping tables identified above, the received single DCI can schedule the first cell, the second cell and the third cell. In such implementations, execution of the determination stage 240 by the UE can based on a determination, by the UE, that the first cell, the second cell and the third cell were scheduled by the single DCI, determining, by the UE, that the fourth TCI-to-Cell mapping table is to be used to indicate TCI states for the first cell, the second cell, and the third cell.

In some implementations, a second set of multiple TCI-to-Cell mapping tables can be activated by MAC CE. In such implementations, the second set of activated TCI-to-Cell mapping tables can include (i) a first TCI-to-Cell mapping table, wherein the first TCI-to-Cell mapping table associates a first TCI table identifier with a first group of cells, wherein each index of the TCI state table identified by the first TCI table identifier comprises at least one TCI state corresponding to each cell in the first group of cells, (ii) a second TCI-to-Cell mapping table, wherein the second TCI-to-Cell mapping table associates a second TCI table identifier with a second group of cells, wherein each index of the TCI state table identified by the second TCI table identifier comprises at least one TCI state corresponding to each cell in the second group of cells, and (iii) a third TCI-to-Cell mapping table, wherein the third TCI-to-Cell mapping table associates a third TCI table identifier with third group of cells, wherein each index of the TCI state table identified by the third TCI table identifier comprises at least one TCI state corresponding to each cell in the third group of cells.

In some implementations using the second set of activated TCI-to-Cell mapping tables identified above, the received single DCI can schedule the first group of cells. In such implementations, execution of the determination stage 240 by the UE can include based on a determination, by the UE, that the first group of cells were scheduled by the single DCI, determining, by the UE, that the first TCI-to-Cell mapping table is to be used to indicate TCI states for the first group of cells.

In some implementations using the second set of activated TCI-to-Cell mapping tables identified above, the received single DCI can schedule the second group of cells. In such implementations, execution of the determination stage 240 by the UE can include based on a determination, by the UE, that the second group of cells were scheduled by the single DCI, determining, by the UE, that the second TCI-to-Cell mapping table is to be used to indicate TCI states for the second group of cells.

In some implementations using the second set of activated TCI-to-Cell mapping tables identified above, the received single DCI can schedule the third group of cells. In such implementations, execution of the determination stage 240 by the UE can include based on a determination, by the UE, that the third group of cells were scheduled by the single DCI, determining, by the UE, that the third TCI-to-Cell mapping table is to be used to indicate TCI states for the third group of cells.

### Second Implementation for TCI Indication Enhancement

Another aspect of the present disclosure is directed towards another TCI indication enhancement. If a UE is capable of supporting up to N cell scheduling by single DCI and if UE is capable of supporting (and if configured) indication of TCI states for multiple cells via a single DCI field (joint field in the DCI), then the UE can be activated by MAC CE with one table, wherein a single index of the TCI table can indicate up to N TCI states corresponding to N cells.

An illustration of this implementation is shown below:

UE can be scheduled with a total of up to 3 cells by single DCI, such as cell 0, cell 1 and cell 2. For cell 0, UE is configured with 128 TCI states and similarly another two sets of 128 TCI states configured for cell 1 and cell 2, respectively. UE receives a MAC CE command to activate one table of TCI states, where an index can contain one or more of the following TCI states:
TCI table index can indicate TCI state for just cell 0
TCI table index can indicate TCI states for cell 0 and cell 1
TCI table index can indicate TCI states for cell 0 and cell 2
TCI table index can indicate TCI states for cell 1 and cell 2
TCI table index can indicate TCI states for cell 0, cell 1 and cell 2

In some implementations, mapping of the TCI states in the indicated index can be either implicit or explicit. For implicit indication, UE is expected to be indicated with another DCI field indication which cells are scheduled, and then the indicated TCI states can be mapped sequentially. For explicit indication, UE is expected to be indicated with just TCI indication, where an enhanced table can be used, wherein each index indicates specifically also the cell index and corresponding TCI state. For example, TCI index 0 may indicate, in one column cells that are scheduled such as cell 0 and cell 1 and in another column indicate first TCI state corresponding to cell 0 and another TCI state corresponding to cell 1. This can also be considered as one method of indicating scheduled cells, in which case, no additional DCI field is needed for indicating the scheduled cells.

In one implementation, the size of the TCI table (i.e. activated TCI indices) can depend on the maximum number of cells for which TCI states need to be indicated. This can be fixed or semi-statically configured.

In some implementations, a single table is defined and each entry includes a TCI State for all the cells that can be scheduled. If only a subset of cells are scheduled, only the corresponding TCI states are used.

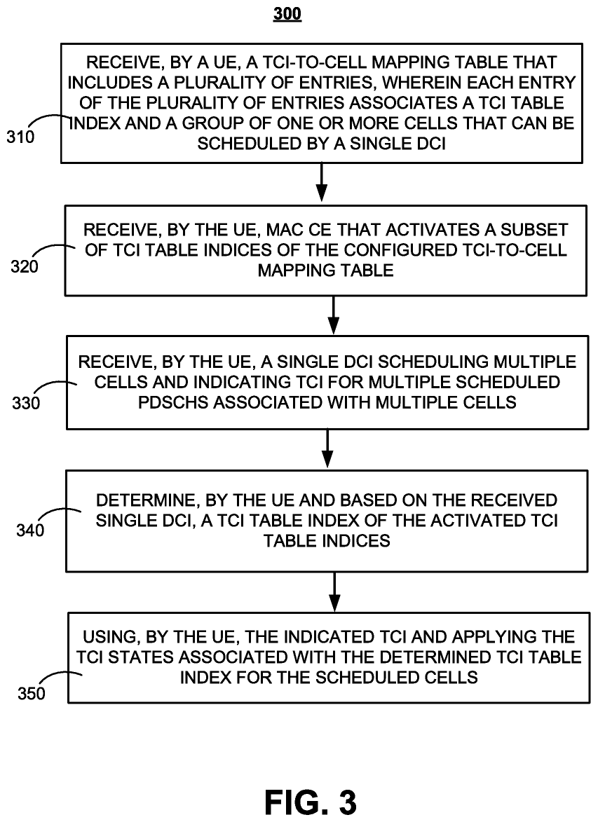

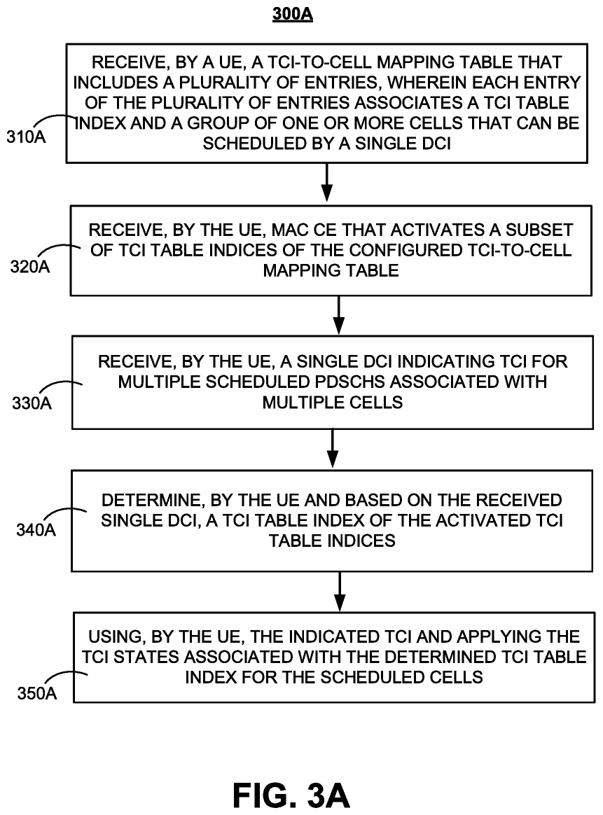

FIG. 3 is a flowchart of another example of a process 300 for TCI configuration and indication. The process 300 will be described as being performed by a UE such as a UE 405 of FIG. 4.

A UE can begin execution of the process 300 by receiving a TCI-to-Cell mapping table that includes a plurality of entries, wherein each entry of the plurality of entries associates a TCI table index and a group of one or more cells that can be scheduled by a single DCI (310). In some implementations, the execution of the receiving operation at stage 310 can include the UE receiving RRC configuration, from the network, that configures the UE to include a table that includes a plurality of entries, wherein each entry of the plurality of entries associate a TCI table index and a TCI state for a group of one or more cells that can be scheduled by a single DCI.

The UE can continue execution of the process 300 by receiving MAC CE that activates a subset of TCI table indices of the configured TCI-to-Cell mapping table (320).

The UE can continue execution of the process 300 by receiving a single DCI scheduling multiple cells and indicating TCI for multiple scheduled PDSCHs associated with multiple cells (330).

The UE can continue execution of the process 300 by determining, based on the received single DCI, a TCI table index of the activated TCI table indices (340).

The UE can continue execution of the process 300 by using the indicated TCI and applying the TCI states associated with the determined TCI table index for the scheduled cells (350). In some implementations, using the indicated TCI states associated with the determined TCI table index for the scheduled cells can include, for example, using the TCI states to indicate a transmission configuration for A UE. For example, TCI states can define one or more QCL-relationships between resources in a resource set and a PDSCH DMRS port.

In some implementations of process 300, the subset of TCI table indices activated by MAC CE can include (i) a first TCI table index, wherein the first TCI table index indicates a TCI state for first group of one or more cells, (ii) a second TCI table index, wherein the second TCI table index indicates a TCI state for a second group of one or more cells, (iii) a third TCI table index, wherein the third TCI table index indicates a TCI state for a third group of one or more cells, and (iv) a third TCI table index, wherein the fourth TCI table index indicates a TCI state for a fourth group of one or more cells.

In some implementations, the first group of the one or more cells associated with the first TCI table index can include multiple cells, the second group of one or more cells associated with the second TCI table index can include multiple cells, the third group of one or more cells associated with the third TCI table index can include multiple cells, or the fourth group of one or more cells associated with the fourth TCI table can include multiple cells.

In some implementations, the first group of the one or more cells associated with the first TCI table index can include multiple cells, the second group of one or more cells associated with the second TCI table index can include multiple cells, the third group of one or more cells associated with the third TCI table index can include multiple cells, and the fourth group of one or more cells associated with the fourth TCI table index can include multiple cells.

In some implementations of the process 300 using the subset of TCI table indices activated by MAC CE activated in process 300, the UE can receive a single DCI scheduling the first group of one or more cells. In such implementations, the execution of the determining stage at 340 can include the UE determining to use the first TCI table index for the scheduled first group of one or more cells.

In some implementations of the process 300 using the subset of TCI table indices activated by MAC CE activated in process 300, the UE can receive a single DCI scheduling the second group of multiple cells. In such implementations, the execution of the determining stage at 340 can include the UE determining to use the second TCI table index for the scheduled second group of multiple cells.

In some implementations of the process 300 using the subset of TCI table indices activated by MAC CE activated in process 300, the UE can receive a single DCI scheduling the third group of multiple cells. In such implementations, the execution of the determining stage at 340 can include the UE determining to use the third TCI table index for the scheduled third group of multiple cells.

In some implementations of the process 300 using the subset of TCI table indices activated by MAC CE activated in process 300, the UE can receive a single DCI scheduling the fourth group of multiple cells. In such implementations, the execution of the determining stage at 340 can include the UE determining to use the fourth TCI table index for the scheduled fourth group of multiple cells.

FIG. 3A is a flowchart of another example of process 300A for TCI configuration and indication. The process 300A will be described as being performed by a UE such as a UE 405 of FIG. 4.

The process 300A is similar to the process 300. However, stage 330A is different than stage 330 of FIG. 3, as the UE in stage 330A receives a single DCI indicating TCI for multiple scheduled PDSCHs associated with multiple cells, but in the example of process 300A, the received DCI in stage 330A does not indicate the multiple cells scheduled for PDSCHs by single DCI. Instead, the certain implementations of the process 300A below the UE can determine the multiple cells scheduled for PDSCHs by single DCI based on the TCI indicated in the single DCI using the activated set of TCI table indices, as described below in more detail.

A UE can begin execution of the process 300A receiving a TCI-to-Cell mapping table that includes a plurality of entries, wherein each entry of the plurality of entries associates a TCI table index and a group of one or more cells that can be scheduled by a single DCI (310). In some implementations, the execution of the receiving operation at stage 310 can include the UE receiving RRC configuration, from the network, that configures the UE to include a table that includes a plurality of entries, wherein each entry of the plurality of entries associate a TCI table index and a TCI state for a group of one or more cells that can be scheduled by a single DCI.

The UE can continue execution of the process 300A by receiving a MAC CE that activates a subset of TCI table indices of the configured TCI-to-Cell mapping table (320).

The UE can continue execution of the process 300A by receiving a single DCI indicating TCI for multiple scheduled PDSCHs associated with multiple cells (330).

The UE can continue execution of the process 300A by determining a TCI table index of the activated TCI table indices (340).

The UE can continue execution of the process 300A by using the indicated TCI and applying the TCI states associated with the determined TCI table index for the scheduled cells (350). In some implementations, applying the indicated TCI states associated with the determined TCI table index can include, for example, using the TCI states to indicate a transmission configuration for A UE. For example, TCI states can define one or more QCL-relationships between resources in a resource set and a PDSCH DMRS port.

In some implementations of the process 300A, the subset of TCI table indices activated by MAC CE can include (i) a first TCI table index, wherein the first TCI table index includes a first column indicating first group of cells comprising at least a first cell and a second column indicating a TCI state for the first cell, (ii) a second TCI table index, wherein the second TCI table index includes a first column indicating a second group of cells comprising at least the first cell and a second cell, a second column indicating a TCI state for the first cell, and a third column indicating a TCI state for the second cell, (iii) a third TCI table index, wherein the third TCI table index includes a first column indicating a third group of cells comprising the first cell and a third cell, a second column indicating a TCI state for the first cell, and a third column indicating a TCI state for the third cell, (iv) a fourth TCI table index, wherein the fourth TCI table index includes a first column indicating a fourth group of cells comprising the second cell and the third cell, a second column indicating a TCI state for the second cell, and a third column indicating a TCI state for the third cell, and (v) a fifth TCI table index, wherein the fifth TCI table index includes a first column indicating a fifth group of cells comprising the first cell, the second cell, and the third cell, a second column indicating a TCI state for the first cell, a third column indicating a TCI state for the second cell, and a fourth column indicating a TCI state for the third cell.

In some implementations, the first group of the one or more cells associated with the first TCI table index can include multiple cells, the second group of one or more cells associated with the second TCI table index can include multiple cells, the third group of one or more cells associated with the third TCI table index can include multiple cells, the fourth group of one or more cells associated with the fourth TCI table index can include multiple cells, or the fifth group of one or more cells associated with the fifth TCI table index can include multiple cells.

In some implementations, the first group of the one or more cells associated with the first TCI table index can include multiple cells, the second group of one or more cells associated with the second TCI table index can include multiple cells, the third group of one or more cells associated with the third TCI table index can include multiple cells, the fourth group of one or more cells associated with the fourth TCI table index can include multiple cells, and the fifth group of one or more cells associated with the fifth TCI table index can include multiple cells.

In some implementations, the received single DCI indicating TCI for multiple scheduled PDSCHs associated with multiple cells comprises an indication of a TCI table index.

In some implementations of the process 300A using the subset of TCI table indices activated by MAC CE activated in process 300A, the received DCI indicating TCI corresponds to the first TCI table index. In such implementations, execution of the determining stage 340A can include the UE determining that the cells to be scheduled by the received single DCI includes the first group of one or more cells based on the first column of the first TCI table index. Thus, even without an explicit indication of the multiple cells scheduled for PDSCHs by single DCI in the DCI, the UE can determine the multiple cells scheduled for PDSCHs by single DCI using the subset of TCI table indices activated by MAC CE in process 300A.

In some implementations of the process 300A using the subset of TCI table indices activated by MAC CE activated in process 300A, the received DCI indicating TCI corresponds to the second TCI table index. In such implementations, execution of the determining stage 340A can include the UE determining that the cells to be scheduled by the received single DCI include the second group of one or more cells based on the first column of the second TCI table index. Thus, even without an explicit indication of the multiple cells scheduled for PDSCHs by single DCI in the DCI, the UE can determine the multiple cells scheduled for PDSCHs by single DCI using the subset of TCI table indices activated by MAC CE in process 300A.

In some implementations of the process 300A using the subset of TCI table indices activated by MAC CE activated in process 300A, the received DCI indicating TCI corresponds to the first TCI table index. In such implementations, execution of the determining stage 340A can include the UE determining to use the first TCI table index. In such implementations, execution of the using stage at 350A can include the UE using the indicated TCI and applying the TCI states in second column of the first TCI table index for the scheduled cells.

In some implementations of the process 300A using the subset of TCI table indices activated by MAC CE activated in process 300A, the received DCI indicating TCI corresponds to the second TCI table index. In such implementations, the execution of the determining stage 340A can include the UE determining to use the second TCI table index. In such implementation, execution of the using stage 350A by the UE can include using the indicated TCI and applying the TCI states in second column of the second TCI table index and the third column of the second TCI Table index for the scheduled cells.

In some implementations of the process 300A using the subset of TCI table indices activated by MAC CE activated in process 300A, the received DCI indicating TCI corresponds to the third TCI table index. In such implementations, execution of the determining stage 340A can include the UE determining to use the third TCI table index. In such implementations, execution of the using stage 350A by the UE can include the UE using the indicated TCI and applying the TCI states in second column of the third TCI table index and the third column of the third TCI Table index for the scheduled cells.

In some implementations of the process 300A using the subset of TCI table indices activated by MAC CE activated in process 300A, the received DCI indicating TCI corresponds to the fifth TCI table index. In such implementations, execution of the determining stage 340A can include the UE determining to use the fifth TCI table index. In such implementations, the execution of the using stage 350A can include the UE using the indicated TCI and applying the TCI states in second column of the third TCI table index, the third column of the fifth TCI Table index, and the fourth column of the fifth TCI table index for the scheduled cells.

### Other Implementations

In some embodiments, more than one TCI field can be indicated in the DCI scheduling multiple cells, wherein the size of each field can depend on one or more of following. In such implementations, the number of TCI fields that can depend on number of cells scheduled. For example for 2 cells, 1 field can be used with up to 8 indices and for 4 cells, 2 fields can be used with up to 4 indices for each field. In some implementations, the number of cells for which TCI state is indicate by one field.

In some embodiments, a single TCI field is indicated in the DCI scheduling multiple cells, wherein the TCI field can be used to indicate index from a single table, but with indices segregated for different cells. For example, if 2 cells are scheduled, then 8 indices are activated, where the first 4 indices are associated with cell 0 and last 4 indices are associated with cell 1. Effectively, it is similar to mapping specific bitfield value for TCI to specific cell.

FIG. 4 is a diagram of an example of a wireless communication system 400, according to some implementations. It is noted that the system of FIG. 4 is merely one example of a possible system, and that features of this disclosure may be implemented in other wireless communication systems.

The following description is provided for an example communication system 400 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 400 includes a number of user devices. As used herein, the term “user devices” may refer generally to devices that are associated with mobile actors or traffic participants in the communication system 400, e.g., mobile (able-to-move) communication devices such as vehicles and pedestrian user equipment (PUE) devices. More specifically, the V2X communication system 400 includes two UEs 405 (UE 405-1 and UE 405-2 are collectively referred to as “UE 405” or “UEs 405”), two base stations 410 (base station 410-1 and base station 410-2 are collectively referred to as “base station 410” or “base stations 410”), two cells 415 (cell 415-1 and cell 415-2 are collectively referred to as “cell 415” or “cells 415”), and one or more servers 435 in a core network (CN) 440 that is connected to the Internet 445.

As shown, certain user devices may be able to conduct communications with one another directly, i.e., without an intermediary infrastructure device such as base station 410-1. As shown, UE 405-1 may conduct communications (e.g., V2X-related communications) directly with UE 405-2. Similarly, the UE 405-2 may conduct communications directly with UE 405-2. Such peer-to-peer communications may utilize a “sidelink” interface such as a PC5 interface. In certain implementations, the PC5 interface supports direct cellular communication between user devices (e.g., between UEs 405), while the Uu interface supports cellular communications with infrastructure devices such as base stations. For example, the UEs 405 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 405 may be physical hardware devices capable of running one or more applications, capable of accessing network services via one or more radio links 420 with a corresponding base station 410, and capable of communicating with one another via sidelink 425. Link 420 may allow the UEs 405 to transmit and receive data from the base station 410 that provides the link 420. The sidelink 425 may allow the UEs 405 to transmit and receive data from one another. The sidelink 425 between the UEs 405 may include one or more channels for transmitting information from UE 405-1 to UE 405-2 and vice versa and/or between UEs 405 and UE-type RSUs (not shown in FIG. 4) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the2nd-stage SCI is carried on the corresponding PSSCH. For example, 2-stage SCI can be used by applying the 1^{st} SCI for the purpose of sensing and broadcast communication, and the 2^{nd} SCI carrying the remaining information for data scheduling of unicast/groupcast data transmission.

In some implementations, the sidelink 425 is established through an initial beam pairing procedure. In this procedure, the UEs 405 identify (e.g., using a beam selection procedure) one or more potential beam pairs that could be used for the sidelink 425. A beam pair includes a transmitter beam from a transmitter UE (e.g., UE 405-1) to a receiver UE (e.g., UE 405-2) and a receiver beam from the receiver UE to the transmitter UE. In some examples, the UEs 405 rank the one or more potential beam pairs. Then, the UEs 405 select one of the one or more potential beam pairs for the sidelink 425, perhaps based on the ranking.

As stated, the air interface between two or more UEs 405 or between a UE 405 and a UE-type RSU (not shown in FIG. 4) may be referred to as a PC5 interface. To transmit/receive data to/from one or more eNBs 410 or UEs 405, the UEs 405 may include a transmitter/receiver (or alternatively, a transceiver), memory, one or more processors, and/or other like components that enable the UEs 405 to operate in accordance with one or more wireless communications protocols and/or one or more cellular communications protocols. The UEs 405 may have multiple antenna elements that enable the UEs 405 to maintain multiple links 420 and/or sidelinks 425 to transmit/receive data to/from multiple base stations 410 and/or multiple UEs 405. For example, as shown in FIG. 4, UE 405 may connect with base station 410-1 via link 420 and simultaneously connect with UE 405-2 via sidelink 425.

In some implementations, the UEs 405 are configured to use a resource pool for sidelink communications. A sidelink resource pool may be divided into multiple time slots, frequency channels, and frequency sub-channels. In some examples, the UEs 405 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 400 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 405 are configured to perform sidelink beam failure recovery procedures. The V2X communication system 400 can enable or disable support of the sidelink beam failure recovery procedures in the UEs 405. More specifically, the V2X communication system 400 can enable or disable support per resource pool or per PC5-RRC configuration (which may depend on UE capability). In the sidelink beam failure recovery procedures, one of the UEs 405 is designated as a transmitter UE (e.g., UE 405-1) and the other UE is designated as a receiver UE (e.g., UE 405-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

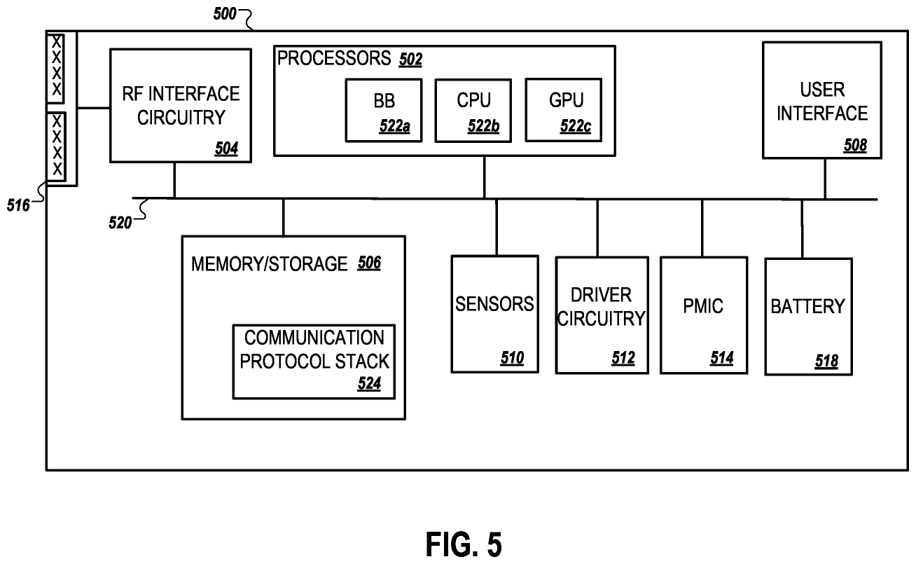

FIG. 5 is a block diagram of an example of user equipment (UE). The UE 500 may be similar to and substantially interchangeable with UEs 405 of FIG. 4.

The UE 500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516.

In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FRI or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 528 and control and allow access to sensor circuitry 528, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500 including DRX as discussed herein. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

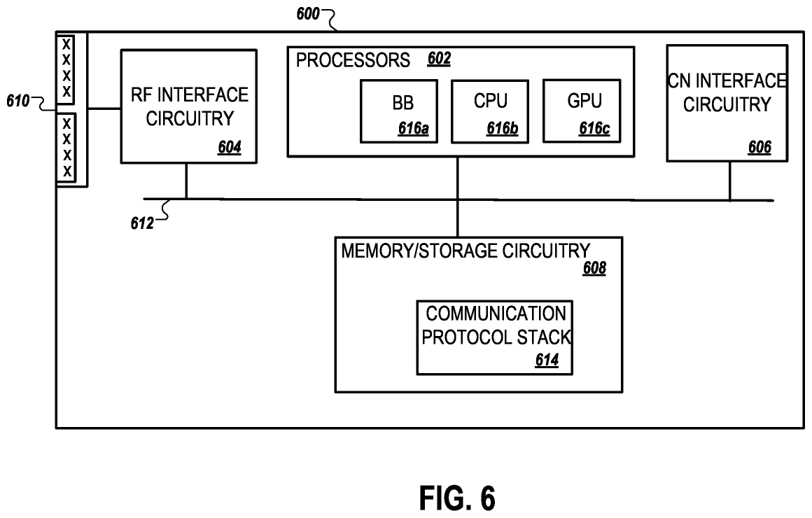

FIG. 6 is a block diagram of an example of an access node. FIG. 6 illustrates an access node 600 (e.g., a base station or gNB), in accordance with some implementations. The access node 600 may be similar to and substantially interchangeable with base stations 410. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 6. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some, implementations, individual serving cells can provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 405 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

In some implementations, all or parts of the access node 600 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 600; a MAC/PHY split wherein RRC, PDCP, RLC, and MAC layers are operated by the CRAN/vBBUP and the PHY layer is operated by the access node 600; or a “lower PHY” split wherein RRC, PDCP, RLC, MAC layers and upper portions of the PHY layer are operated by the CRAN/vBBUP and lower portions of the PHY layer are operated by the access node 600.

In V2X scenarios, the access node 600 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-18. (canceled)

19. One or more processors configured to, when executing instructions stored in a memory, perform operations comprising:
configure a transmission configuration indicator (TCI) table for downlink scheduling via downlink control information (DCI), the TCI table comprising a plurality of entries, each entry of the TCI table comprising a respective TCI index for each cell in a scheduled cell set; and
obtaining the DCI that schedules a respective physical downlink shared channel (PDSCH) transmission on each cell in the scheduled cell set, the DCI comprising a field that indicates an entry of the TCI table; and
determining a respective TCI state for each cell in the scheduled cell set based at least on the DCI.

20. The one or more processors of claim 19, wherein the field is not present in the DCI when a tci-PresentInDCI parameter is not enabled.

21. The one or more processors of claim 19, wherein a size of the field in the DCI corresponds to a size of the configured TCI table.

22. The one or more processors of claim 19, wherein the scheduled cell set comprises a plurality of cells.

23. The one or more processors of claim 19, wherein the DCI schedules one PDSCH transmission per cell.

24. The one or more processors of claim 19, the operations further comprising receiving the respective PDSCH transmission using the respective TCI state determined by the field in the DCI.

25. The one or more processors of claim 19, wherein each TCI index in the entry corresponds to a TCI state for a particular cell in the scheduled cell set.

26. The one or more processors of claim 19, wherein a number of TCI indices in each entry of the TCI table corresponds to a number of cells in the scheduled cell set.

27. The one or more processors of claim 26, wherein a scheduled cell indicator field of the DCI indicates the number of cells in the scheduled cell set.

28. The one or more processors of claim 25, the operations further comprising determining that a tci-PresentInDCI parameter is enabled for a control resource set (CORESET) in which the DCI is received, wherein determining the respective TCI state for each cell in the scheduled cell set is based at least on the tci-PresentInDCI parameter.

29. The one or more processors of claim 19, wherein the DCI is used for scheduling one PDSCH transmission in one cell, or multiple PDSCH transmissions in multiple cells with one PDSCH per cell.

30. A method comprising:
receiving control signaling that configures a transmission configuration indicator (TCI) table for downlink scheduling via downlink control information (DCI), the TCI table comprising a plurality of entries, each entry of the TCI table comprising a respective TCI index for each cell in a scheduled cell set; and
receiving the DCI that schedules a respective physical downlink shared channel (PDSCH) transmission on each cell in the scheduled cell set, the DCI comprising a field that indicates an entry of the TCI table; and
determining a respective TCI state for each cell in the scheduled cell set based at least on the DCI.

31. The method of claim 30, wherein the field is not present in the DCI when a tci-PresentInDCI parameter is not enabled.

32. The method of claim 30, wherein a size of the field in the DCI corresponds to a size of the TCI table configured by the control signaling.

33. The method of claim 30, wherein the scheduled cell set comprises a plurality of cells.

34. The method of claim 30, wherein the DCI schedules one PDSCH transmission per cell.

35. The method of claim 30, further comprising receiving the respective PDSCH transmission using the respective TCI state determined by the field in the DCI.

36. The method of claim 30, wherein each TCI index in the entry corresponds to a TCI state for a particular cell in the scheduled cell set.

37. The method of claim 30, wherein a number of TCI indices in each entry of the TCI table corresponds to a number of cells in the scheduled cell set.

38. A user equipment (UE) configured to perform operations comprising:
receiving control signaling that configures a transmission configuration indicator (TCI) table for downlink scheduling via downlink control information (DCI), the TCI table comprising a plurality of entries, each entry of the TCI table comprising a respective TCI index for each cell in a scheduled cell set; and
receiving the DCI that schedules a respective physical downlink shared channel (PDSCH) transmission on each cell in the scheduled cell set, the DCI comprising a field that indicates an entry of the TCI table; and
determining a respective TCI state for each cell in the scheduled cell set based at least on the DCI.
